(19) United States
(12) Patent Application Publication
(10) Pub. No.: US 2018/0156955 A1
(43) Pub. Date: Jun. 7, 2018

(54) Limiting Viewing Angle Sheet and Manufacturing Method Thereof

(71) Applicant: Sichuan Longhua Film Co., Ltd, Mianyang (CN)

(72) Inventors: Rui-Min Diao, Mianyang (CN); Yao-Chang Wang, Zhubei City (TW); Yi-Ping Hsieh, Zhudong Township (TW)

(21) Appl. No.: 15/823,306

(22) Filed: Nov. 27, 2017

(30) Foreign Application Priority Data
Dec. 6, 2016 (CN) 201611108765.2

(51) Int. Cl. G02B 5/30; G02B 5/02

(52) U.S. Cl. CPC G02B 5/3041; G02B 5/3083; G02B 5/0273; G02B 5/021

(57) ABSTRACT

A limiting viewing angle sheet comprises a substrate, a transparent layer and an opaque pattern. The transparent layer is disposed on the substrate, and comprises a top plane and a plurality of grooves formed on the top plane, wherein the width of each of the grooves is decreased from the top plane to the substrate. The opaque pattern is formed within the grooves, and comprises a top surface and a plurality of side planes, wherein the transparent layer is exposed from the top surface, and the side planes extend from the top surface. The opaque pattern comprised different included angels respectively between the top surface and two of the side planes.

### FIELD OF THE INVENTION

The invention relates to an optical film and the manufacturing method thereof, and more particularly to a limiting viewing angle sheet and the manufacturing method thereof.

### BACKGROUND OF THE INVENTION

A limiting viewing angle sheet is an optical film capable of limiting viewing angles, which limits the emerging ray in a specified viewing angle. Most of the current-used limiting viewing angle sheets include symmetrical viewing angles, which are symmetrical with respect to the normal of light-emergent surface. Applicable technical fields are rather limited for such limiting viewing angle sheets with symmetrical viewing angles, which are mostly applied as privacy filters, and the applications other than privacy filters are very rare.

### SUMMARY OF THE INVENTION

The present invention provides a limiting viewing angle sheet capable of generating asymmetric viewing angles.

The present invention provides a limiting viewing angle sheet comprising a multi-layer structure capable of generating asymmetric viewing angles.

The present invention provides a manufacturing method for manufacturing the above-mentioned limiting viewing angle sheet.

According to an embodiment of the present invention, a limiting viewing angle sheet is provided, which comprises a substrate, a transparent layer and an opaque pattern. The transparent layer is disposed on the substrate and comprises a top plane and a plurality of grooves formed on the top plane, wherein the width of each of the grooves is reduced form the top plane to the substrate. The opaque pattern is formed within the grooves, and comprises a top surface and a plurality of side planes, wherein the transparent layer is exposed from the top surface, and the side planes extend from the top surface. The opaque pattern comprises two included angles respectively between the top surface and two of the side planes, and the two included angles are different to each other.

According to an embodiment of the above-mentioned limiting viewing angle sheet, the opaque pattern is a mesh pattern, a bar pattern, or an array dot pattern.

According to an embodiment of the above-mentioned limiting viewing angle sheet, one of the grooves comprises a plurality of side walls, and the side walls of the same groove intersect at a point or a line.

According to an embodiment of the above-mentioned limiting viewing angle sheet, wherein the substrate comprises a support plane and the transparent layer is disposed on the support plane. The side planes of the opaque pattern comprise a plurality of first side planes and a plurality of second side planes. The opaque pattern comprises a width between two adjacent ones of the first side planes and the second side planes, which is gradually reduced from the top surface toward the support plane.

According to an embodiment of the above-mentioned limiting viewing angle sheet, an included angle between each of the first side planes and the support plane is not equal to an included angle between each of the second side planes and the support plane.

According to another embodiment of the present invention, a limiting viewing angle sheet is provided, which comprises a substrate, a plurality of transparent layers and a plurality of opaque patterns. These transparent layers stack to each other, and are disposed on the substrate, wherein each of the transparent layers comprises a top plane and a plurality of grooves formed on the top plane. Each of the grooves comprises a width gradually reduced from the top plane to the substrate. These opaque patterns are respectively formed within the grooves of one of the transparent layers. Each of the opaque patterns comprises a top surface, a plurality of first side planes and a plurality of second side planes, wherein the first side planes and the second side planes extend from the top surface. Each of the opaque patterns comprises two different included angles respectively between the first side planes and the top surface, and the second side planes and the top surface.

According to an embodiment of the above-mentioned limiting viewing angle sheet, the substrate comprises a support plane, and the transparent layers are disposed on the support plane, each of the opaque patterns comprises a width between two adjacent ones of the first side planes and the second side planes, which is gradually decreased from the top surface to the support plane.

According to an embodiment of the above-mentioned limiting viewing angle sheet, the limiting viewing angle sheet further comprises at least a glue layer. The glue layer is disposed between two adjacent ones of the transparent layers.

According to another embodiment of the present invention, a method for manufacturing a limiting viewing angle sheet is provided. First of all, forming at least a transparent layer wherein each of the transparent layers comprises a top plane and a plurality of grooves formed on the top plane, wherein each of the grooves comprises a width gradually decreased from the top plane to the substrate. Then, the opaque pattern is formed within the grooves. After that, a portion of the transparent layer and a portion of the opaque pattern are removed for decreasing a thickness of the transparent layer and a thickness of the opaque pattern.

According to an embodiment of the manufacturing method for the above-mentioned limiting viewing angle sheet, forming the transparent layer comprises steps of: forming a transparent film on the substrate; and having a mold pressed against the transparent film for forming the grooves.

According to an embodiment of manufacturing method of the above-mentioned limiting viewing angle sheet, when the mold is pressed against the transparent film, heat the transparent film at the same time.

According to an embodiment of the manufacturing method for the above-mentioned limiting viewing angle sheet, wherein forming the opaque pattern within the grooves comprises steps of filling an opaque filling material within the grooves; and solidifying the opaque filling material.

According to an embodiment of the manufacturing method for the above-mentioned limiting viewing angle sheet, the opaque filling material is an ink

According to an embodiment of the manufacturing method for the above-mentioned limiting viewing angle sheet, removing a portion of the transparent layer and a portion of the opaque pattern comprises polishing the transparent layer and the opaque pattern.

According to an embodiment of the manufacturing method for the above-mentioned limiting viewing angle sheet, the above-mentioned substrate is the above-mentioned limiting viewing angle sheet.

The foregoing description is merely an overview of the technical solution of the present invention and can be implemented in accordance with the teachings of the present invention in order to enable a clearer understanding of the technical means of the present invention and to make the present and other objects, features and advantages of the present invention more obvious, and the following detailed description will be made in detail with reference to the accompanying drawings.

### BRIEF DESCRIPTION OF THE DRAWINGS

FIG. 1A is a schematic top view of a limiting viewing angle sheet in accordance with an embodiment of the invention.

FIG. 1B is a schematic cross-sectional view alone line 1B-1B of FIG. 1A.

FIG. 2A is a schematic top view of a limiting viewing angle sheet in accordance with another embodiment of the invention.

FIG. 2B is a schematic top view of a limiting viewing angle sheet in accordance with still another embodiment of the invention.

FIG. 2C is a schematic cross-sectional view alone line 2C-2C of FIG. 2B.

FIGS. 3A-3C are schematic cross-sectional views illustrating a manufacturing of the limiting viewing angle sheet of FIG. 1B.

FIG. 4 is a schematic cross-sectional view of a limiting viewing angle sheet in accordance with another embodiment of the invention.

FIG. 5 is a schematic cross-sectional view of a limiting viewing angle sheet in accordance with still another embodiment of the invention.

FIGS. 6A-6B are schematic cross-sectional views illustrating a manufacturing of the limiting viewing angle sheet of FIG. 5.

### DETAILED DESCRIPTION OF PREFERRED EMBODIMENTS

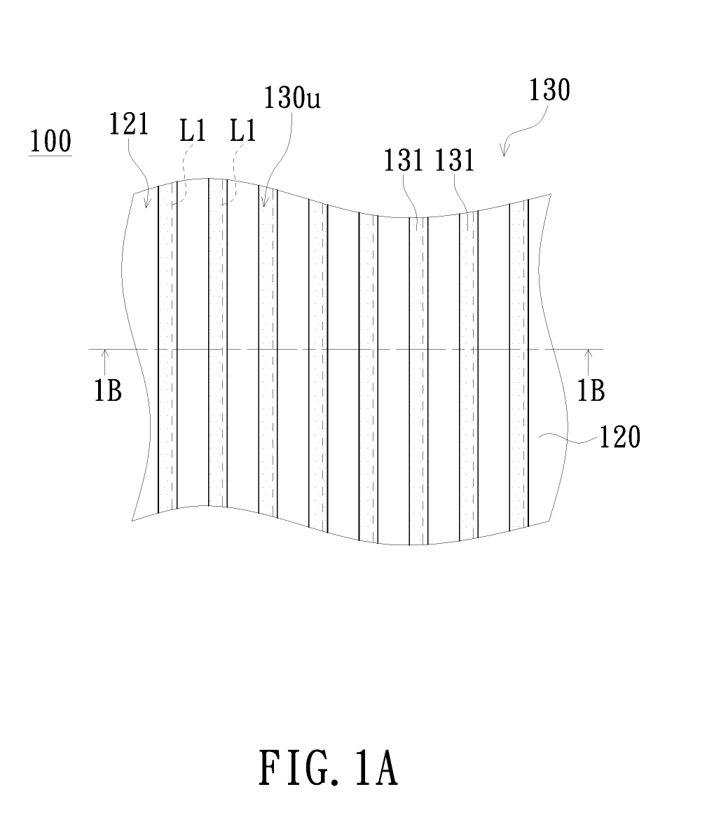

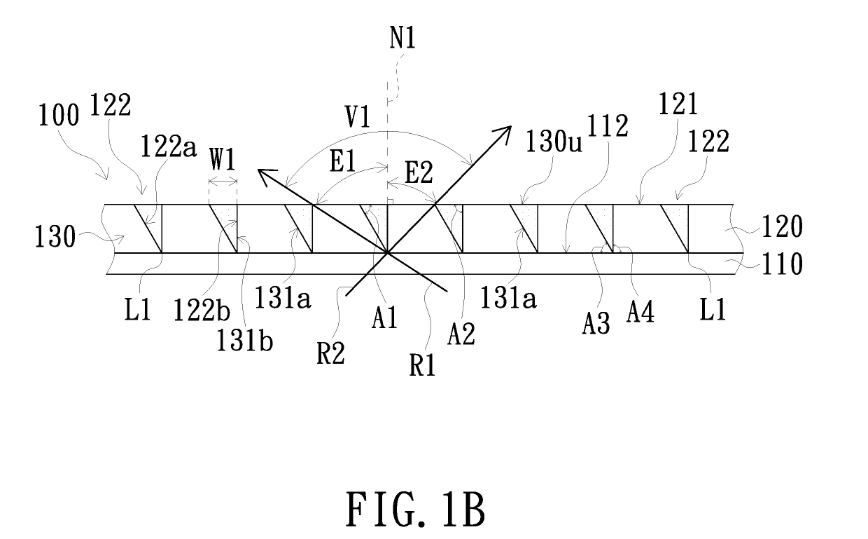

FIG. 1A is a schematic top view of a limiting viewing angle sheet in accordance with an embodiment of the invention, and FIG. 1B is a schematic cross-sectional view alone line 1B-1B of FIG. 1A. Referring to FIG. 1A and FIG. 1B, the limiting viewing angle sheet 100 includes a substrate 110, a transparent layer 120 and an opaque pattern 130. The transparent layer 120 is disposed on the substrate 110, wherein the substrate 110 includes a support plane 112, and the transparent layer 120 is disposed on the support plane 112.

The transparent layer 120 includes a top plane 121 and a plurality of grooves 122. These grooves 122 are formed on the top plane 121, and extend from the top plane 121 to the substrate 110. At least one of the grooves 122 includes a plurality of side walls, and the side walls of the same groove 122 intersect at a point or a line. As shown in FIG. 1A and FIG. 1B, for example, each of the grooves 122 includes two side walls, i.e. the side walls 122a and 122b, and the side walls 122a and 122b of each of the grooves 122 will intersect at a line L1, so that the width W1 of each of the grooves 122 is gradually decreased from the top plane 121 to the substrate 110. Furthermore, the maximum width W1 of each of the grooves 122 will be greater than 1 μm, e.g. 10 μm or greater than 10 μm.

The opaque pattern 130 is formed within the transparent layer 120, and is especially formed within the grooves 122. The opaque pattern 130 includes a top surface 130u, which is exposed from the transparent layer 120, wherein the top plane 121 is flush with the top surface 130u. The opaque pattern 130 further includes a plurality of side planes, and the side planes extend from the top surface 130u. The opaque pattern 130 includes two included angles respectively between the top surface 130u and two of the side planes, and the two included angles, e.g. A1 and A2 shown in FIG. 1B, are different to each other.

As shown in FIG. 1B, for example, the side planes of the opaque pattern 130 are a plurality of first side planes 131a and a plurality of second side planes 131b, wherein the included angle A1 is formed between each of the first side planes 131a and the top surface 130u, while the included angle A2 is formed between each of the side planes 131b and the top surface 130u. As shown in FIG. 1B, the included angle A1 is obviously not equal to the included angle A2, and the included angle A1 is smaller than the included angle A2, so that the first side plane 131a and the second side plane 131b are asymmetric to each other with respect to the normal N1 of the top surface 130u. Furthermore, the included angel A3 between each of the first side planes 131a and the support plane 112 is not equal to the included angle A4 between each of the second side planes 131b and the support plane 112, as shown in FIG. 1B.

The color of the opaque pattern 130 may be black or deep blue. Therefore, the opaque pattern 130 has high light absorbance, and thus is capable of blocking and absorbing light. Since the first side plane 131a and the second side plane 131b are asymmetric to each other with respect to the normal N1, ray R1 and R2 which transmit the limiting viewing angle sheet 100 are blocked by the opaque pattern 130 and thus emerge from the limiting viewing angle sheet 100 alone the maximum emergence angles E1 and E2, wherein the maximum emergence angles E1 and E2 are not equal to each other. Hence, the limiting viewing angle sheet 100 is capable of generating asymmetric viewing angle V1, which is asymmetric with respect to the normal N1, wherein the viewing angle V1 is equal the sum of the maximum emergence angles E1 and E2. Through the asymmetric viewing angle V1, the limiting viewing angle sheet 100 show in FIG. 1A is capable of limiting the viewing angle in the transverse direction.

The opaque pattern 130 may be formed by solidified fluid, e.g. solidified ink. Therefore, the shape of the opaque pattern 130 may be determined by the shape of the grooves 122. For example, the side walls 122a and 122b of the grooves 122 may define the first side plane 131a and the second side plane 131b of the opaque pattern 130, respectively. Furthermore, in this embodiment, the width W1 of the groove 122 is equal to the width of the opaque pattern 130 between two adjacent ones of the first side planes 131a and the second side planes 131b, which is also decreased from the top surface 130u to the support plane 112 of the substrate 110.

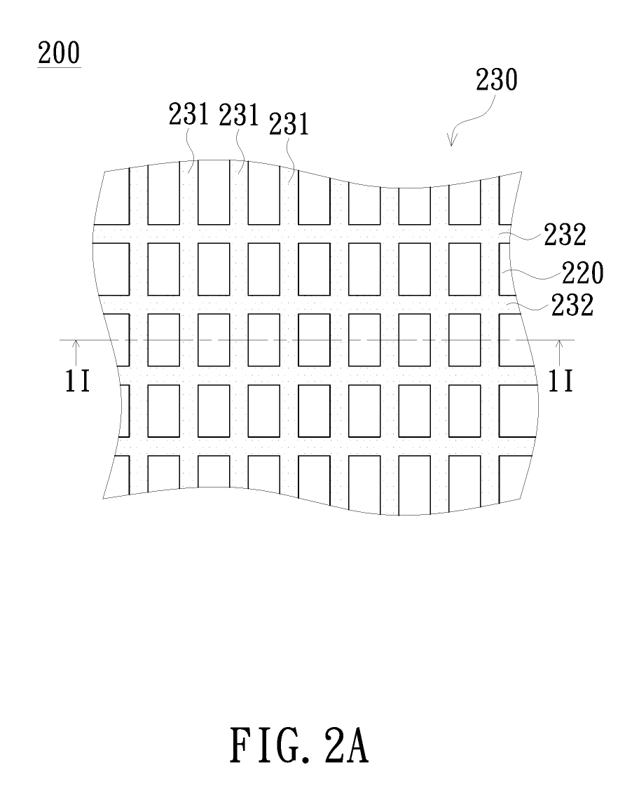

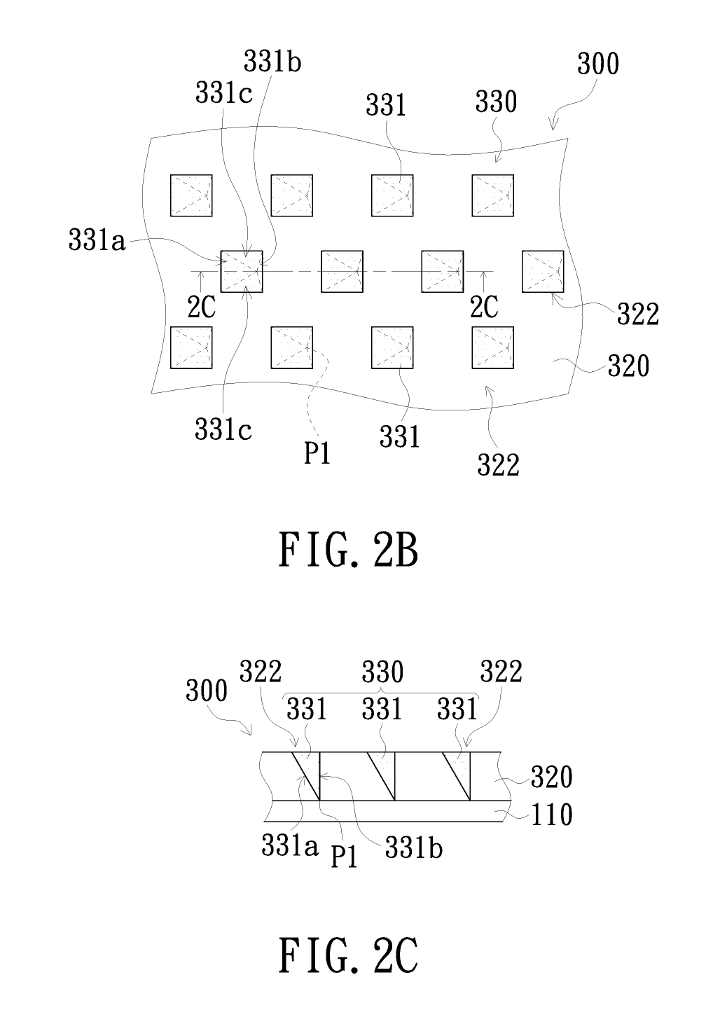

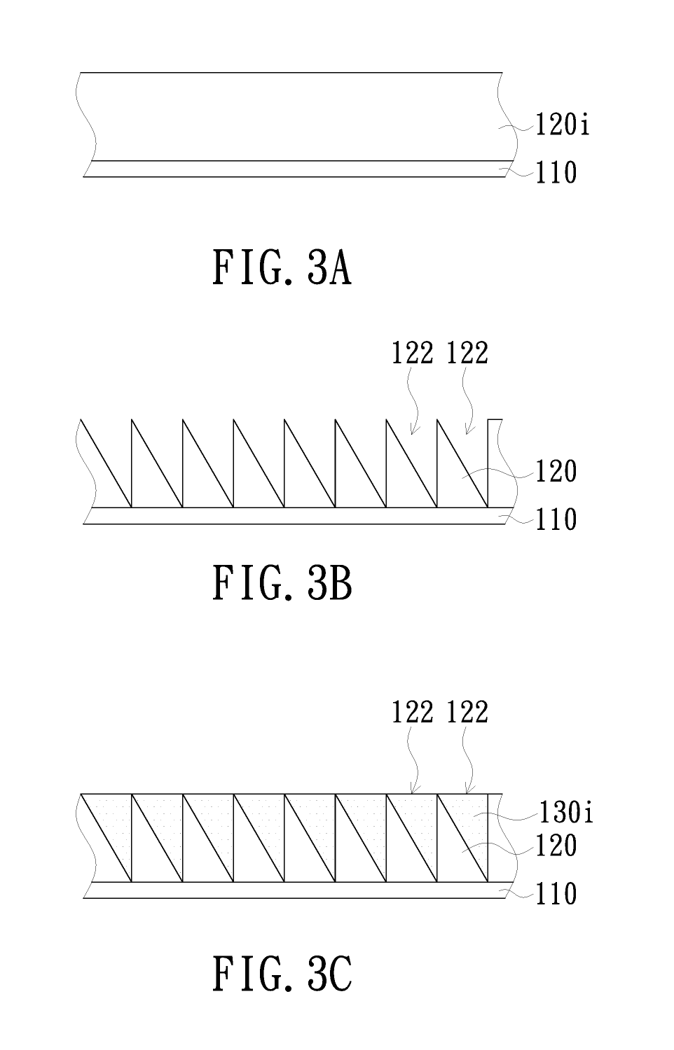

In this embodiment, the opaque pattern 130 is a bar pattern, as shown in FIG. 1A. More specifically, the opaque pattern 130 may includes a plurality of opaque strips 131 parallel to each other. Each of the opaque strips 131 includes a first side plane 131a and a second side plane 131b, and the first side plane 131a and the second side plane 131b of the same opaque strip 131 are opposite to each other. The width of each of the opaque strips 131 is equal to the width W1. Since the maximum value of the width W1 is greater than 1 μm, these opaque strips 131 will not cause significant light diffraction. That is to say, dispersion will not be generated within the limiting viewing angle sheet 100 substantially. Furthermore, the opaque pattern 130 is a bar pattern in the embodiment shown in FIG. 1A. However, in other embodiments, the opaque pattern 130 may be other patterns, such as the opaque patterns 230 and 330 shown in FIG. 2A and FIG. 2B.

Referring to FIG. 2A, the limiting viewing angle sheet 200 is similar to the limiting viewing angle sheet 100 as described above. For example, the limiting viewing angle sheet 200 also includes the substrate 110 (not shown in FIG. 2A), the transparent layer 220 and the opaque pattern 230. Materials and the method for forming the opaque pattern 230 are the same as those of the opaque pattern 130, and the cross-sectional structure alone line 1I-1I in FIG. 2A is substantially the same as the cross-sectional structure as illustrated in FIG. 1B. The identical features of the limiting viewing angle sheets 100 and 200 will not be repeatedly described, nor be indicated in the drawings, and the following description will be focus on the differences between them.

Different from the limiting viewing angle sheet 100 shown in FIG. 1A, the limiting viewing angle sheet 200 illustrated in FIG. 2A includes an opaque pattern 230 which is a mesh pattern. In particular, the opaque pattern 230 includes a plurality of longitudinal strips 231 and a plurality of transverse strips 232, and these longitudinal strips 231 are aligned with the transverse strips 232 so as to form a mesh pattern as shown in FIG. 2A. The cross-sectional structure of both the longitudinal strips 231 and the transverse strips 232 is the same as that of the opaque strips 131, and the limiting viewing angle sheet 200 may limit the viewing angle in both the longitudinal and transverse directions. In contrast to the limiting viewing angle sheet 100, the limiting viewing angle sheet 200 is limited on the viewing angle in one more direction (longitudinal). In addition, the width of each of the longitudinal strips 231 and the transverse strips 232 is about 1 μm or more, so that the longitudinal strips 231 and the transverse strips 232 do not cause significant light diffraction.

FIG. 2B is a schematic top view of a limiting viewing angle sheet in accordance with still another embodiment of the invention, and FIG. 2C is a schematic cross-sectional view alone line 2C-2C of FIG. 2B. Referring to FIG. 2B and FIG. 2C, the limiting viewing angle sheet 300 of the present embodiment is similar to the limiting viewing angle sheets 100 and 200 of the foregoing embodiment. For example, the limiting viewing angle sheet 300 also includes a substrate 110, a transparent layer 320, and an opaque pattern 330, wherein the constituent material and the forming method of the opaque pattern 330 are the same as those of the opaque pattern 130, and the cross-sectional structure of the limiting viewing angle sheet 300 shown in FIG. 2C is also the same as the cross-sectional structure of the limiting viewing angle sheet 100 shown in FIG. 1B. The identical features of the limiting viewing angle sheets 100, 200 and 300 will not be repeatedly described, and the following description will be focus on the differences between both.

Unlike the limiting viewing angle sheets 100 and 200, the opaque pattern 330 is an array dot pattern. In detail, the opaque pattern 330 includes a plurality of opacity points 331, and these opacity points 331 are arranged in an array, as shown in FIG. 2B. In the limiting viewing angle sheet 300, the transparent layer 320 also has a plurality of grooves 322, and these opaque points 331 of the opaque pattern 330 are formed within the grooves 322, respectively. However, unlike the grooves 122 described above, the side walls of the same groove 322 intersect at one point. In the example of FIGS. 2B and 2C, each groove 322 has a side wall 331a, a side wall 331b and two side walls 331c, respectively, where the four side walls 331a, 331b and 331c intersect at a point P1. It can be seen that each groove 322 is a tapered hole and the shape of the opaque point 331 is a tapered body. In addition, the width of each opaque point 331 is about 1 μm or more, so that these opaque points 331 will not cause significant light diffraction.

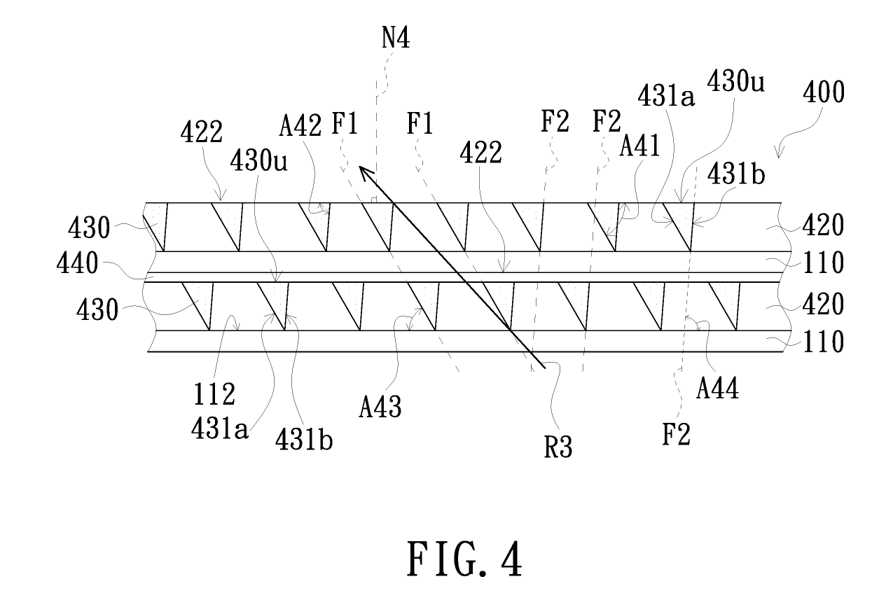

FIGS. 3A-3C are schematic cross-sectional views illustrating a manufacturing of the limiting viewing angle sheet of FIG. 1B. Although the method of manufacturing the limiting viewing angle sheet 100 is disclosed in FIGS. 3A to 3C, those skilled in the art may manufacture the limiting viewing angle sheet 200 according to the common known knowledge and the method of FIGS. 3A to 3C as disclosed below. Therefore, it is noticeable that, the limiting viewing angle sheet 100 of FIG. 1B is only illustrative in FIGS. 3A to 3C, and it does not mean that the method illustrated in FIGS. 3A to 3C can only be used to fabricate the limiting viewing angle sheet 100. The method disclosed in FIGS. 3A to 3C may also be utilized for manufacturing the limiting viewing angle sheet 200 or 300.

Referring to FIG. 3A and FIG. 3B, in the manufacturing method of the limiting viewing angle sheet 100, a transparent layer 120 is firstly formed on the substrate 110, and the method of forming the transparent layer 120 may include the following steps. A transparent film 120i is formed on the substrate 110 (as shown in FIG. 3A). In particular, the substrate 110 is transparent and may be a flexible board or a rigid board, and the material forming the substrate 110 may be a polymeric material or glass, wherein the polymeric material is, for example, a rigid material such as polymethylmethacrylate (PMMA) or polycarbonate (PC), or a flexible material such as polyimide (PI) or polyethylene terephthalate (PET). The transparent film 120i may be formed by adhering, lamination or applying, and the transparent film 120i may be a polymeric material film which may be the same material as the substrate 110.

Then, the mold (not shown) is pressed against the transparent film 120i to form the grooves 122, i.e., the transparent film 120i becomes the transparent layer 120 having the grooves 122. The transparent film 120i may be thermosetting, so that when the mold is pressed against the transparent film 120i, the transparent film 120i may be heated to cure the transparent film 120i to form the transparent layer 120. The transparent film 120i may also have photocurable properties. For example, the constituent material of the transparent film 120i may be a UV-curable adhesive, so that when the mold is pressed against the transparent film 120i, it can be cured by UV irradiation on the transparent film 120i to form a transparent layer 120. In addition, when the transparent film 120i is formed by sticking or filming, the transparent film 120i may not be subjected to any curing process, and during the process of pressing the transparent film 120i, it may not be heated or irradiated with ultraviolet light on the transparent film 120i.

The shape of the mold may be plate-like or cylindrical, and the mold may be used to contact the surface structure of the transparent film 120i to determine the shape of the groove 122. For example, the surface structure of the mold may be a plurality of juxtaposed ribs which can press a plurality of striped grooves 122 on the transparent film 120i. The surface structure of the mold may also be a mesh-like relief which can be pressed on the transparent film 120i in a mesh-like groove (not shown in FIG. 2A) in FIG. 2A which holds the opaque pattern 230. Alternatively, the structure of the mold may also be a plurality of studs capable of pressing a plurality of grooves 322 in FIG. 2B which hold the opaque pattern 330 on the transparent film 120i.

Referring to FIG. 3C, an opaque pattern 130 is formed within the grooves 122. In the present embodiment, the method of forming the opaque pattern 130 may include the following steps. In these grooves 122 are filled with an opaque material 130i, which may be a fluid, such as an ink. Since the opaque material 130i is a fluid, the method of filling the grooves 122 with the opaque material 130i may be spraying or printing. Next, the opaque material 130i is cured to make the opaque material 130i into the opaque pattern 130, wherein the method of curing the opaque material 130i may be heating the opaque material 130i, or irradiating the opaque material 130i with ultraviolet light.

Referring to FIG. 3C and FIG. 1B, a portion of the transparent layer 120 and a portion of the opaque pattern 130 are removed to reduce the thickness of the transparent layer 120 and the thickness of the opaque pattern 130. After that step, the limited viewing angle sheet 100 is substantially finished (as shown in FIG. 1B). The method of removing a portion of the transparent layer 120 and a portion of the opaque pattern 130 may be polishing the transparent layer 120 and the opaque pattern 130, so that the top surface 130u of the opaque pattern 130 is flush with the top plane 121 of the transparent layer 120.

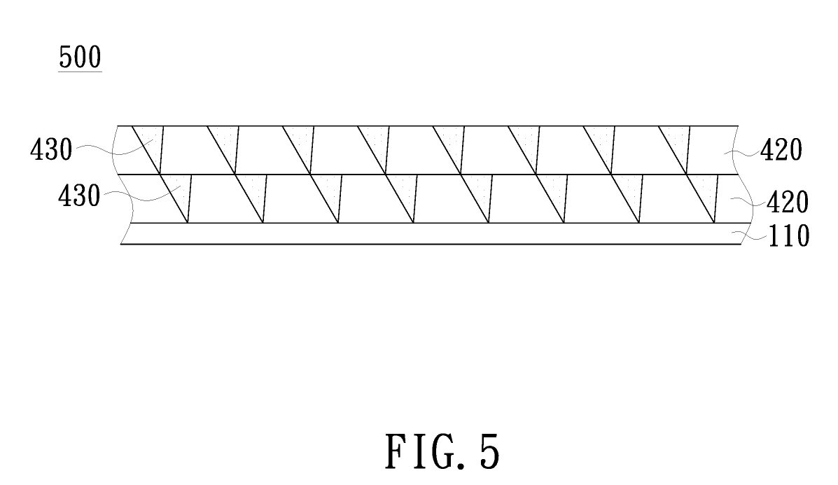

It is noticeable that, in the above-mentioned embodiments, the limiting viewing angle sheets 100, 200, and 300 include only a single transparent layer (e.g., the transparent layer 120 or 320), so the limiting viewing angle sheets 100, 200, and 300 are all include a single layer structure, but in other embodiments, the limiting viewing angle sheet may also have a multi-layer structure, as shown in FIG. 4.

Referring to FIG. 4, which discloses a limiting viewing angle sheet 400 according to another embodiment of the present invention. The major difference between the limiting viewing angle sheet 400 and the aforementioned viewing angle sheets 100, 200 and 300 is that the limiting viewing angle sheet 400 has a multilayer structure, which includes at least one substrate 110 (two substrates 110 are shown in FIG. 4), a plurality of transparent layers 420 stacked to each other on the substrates 110, and a plurality of opaque patterns 430 formed within the multiple transparent layers 420. The opaque patterns 430 may be the same as the opaque pattern 130 of the foregoing embodiment in constitute of material and the forming method, and the transparent layers 420 may be formed by the transparent film 120i (referring to FIG. 3A).

These transparent layers 420 are disposed on the support plane 112 of the substrate 110. Each of the transparent layers 420 has a plurality of grooves 422, and each of the multiple opaque patterns 430 is formed within the grooves 422 of one of the transparent layers 420. The grooves 422 of at least one of the transparent layers 420 may be the aforementioned grooves 122 or 322, and at least one of the opaque patterns 430 may be the same shape as the opaque pattern 130, 230, or 330. For example, the grooves 422 of each of the transparent layers 420 may be the grooves 122, and each of the opaque patterns 430 may be a bar pattern (i.e., the opaque pattern 130).

Each of the opaque patterns 430 has a top surface 430u, a plurality of the first side planes 431a and a plurality of the second side planes 431b, wherein the first side planes 431a and the second side planes 431b extend from the top surface 430u. Each of the opaque patterns 430 includes included angles A41 and A42 which are not equal to each other and between the first side plane 431a and the top surface 430u, and between the second side plane 431b and the top surface 430u, respectively. As shown in FIG. 4, for example, the included angle A41 is smaller than the included angle A42.

The first side planes 431a are respectively located in a plurality of first reference planes F1 parallel to each other, and the second side planes 431b are located in a plurality of second reference planes F2 parallel to each other, wherein the first reference planes F1 and the second reference planes F2 are dummy planes and may be considered as extensions of the first side planes 431a and the second side planes 431b, respectively. The included angle A43 between the first reference plane F1 and the support plane 112 is not equal to the included angle A44 between the second reference plane F2 and the support plane 112. As shown in FIG. 4, for example, the included angle A43 is less than the included angle A44. In FIG. 4, the layer number of the transparent layers 420 and the opaque patterns 430 are designed to widen the angle between the outgoing light and the top surface 430u normal N4 (i.e., the exit angle), and may even block the light traveling alone the normal N4.

In particular, the limiting viewing angle sheet 400 may be substantially stacked by a plurality of limiting viewing angle sheets 100, 200 or 300, and these limiting viewing angle sheets 100, 200 or 300 may be bonded to each other. For example, in the embodiment of FIG. 4, the limiting viewing angle sheet 400 includes a glue layer 440, which may be optical clear adhesive (OCA). The glue layer 440 is bonded to the upper one of the substrates 110 and the lower one of the transparent layers 420 and the opaque pattern 430, and is located between two adjacent transparent layers 420.

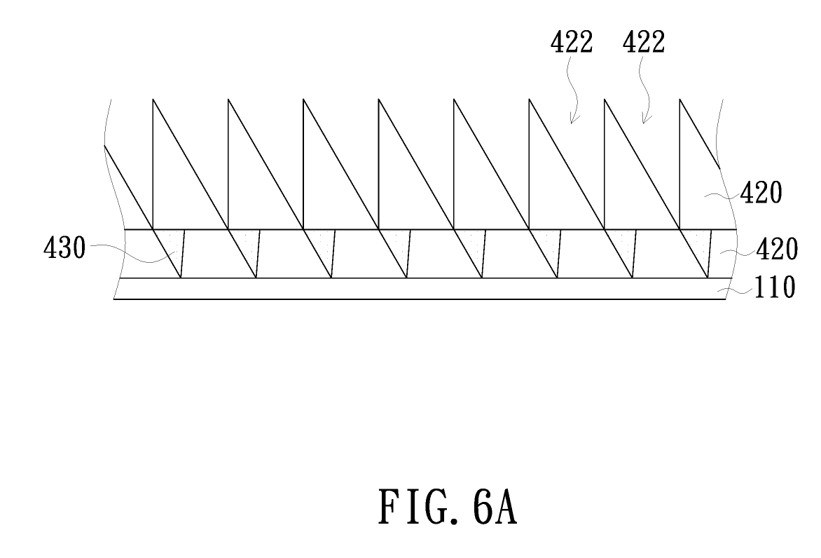

It is to be noted that in the embodiment of FIG. 4, the limiting viewing angle sheet 400 is substantially formed by bonding two viewing angle sheets of the foregoing embodiment (e.g., the limiting viewing angle sheets 100, 200 or 300). However, in other embodiments, the limiting viewing angle sheet 400 may substantially comprise three or more of the limiting viewing angle sheets of the foregoing embodiments, and the limiting viewing angle sheet 400 may include multiple glue layers 440, thus the glue layer 440 of the limiting viewing angle sheet 400 is not limited to only one layer. In addition, in other embodiments, the limiting viewing angle sheet 400 may not include a glue layer 440, as shown in FIG. 5.

Referring to FIG. 5, which illustrates a limiting viewing angle sheet 500 according to another embodiment of the present invention, the structure is very similar to that of the limiting viewing angle sheet 400 of FIG. 4, and both have same effectiveness and advantages. For example, the limiting viewing angle sheet 500 also includes a substrate 110, a plurality of transparent layers 420 stacked on top of the substrate 110, and a plurality of opaque patterns 430 formed within these transparent layers 420. However, the limiting viewing angle sheet 500 does not have a glue layer 440, and includes only one substrate 110. In the limiting viewing angle sheet 500 of FIG. 5, the substrate 110 is located below these transparent layers 420 and is not located between adjacent layers of the transparent layers 420, and two adjacent layers of the transparent layers 420 are not only connected to each other, but also contact to each other.

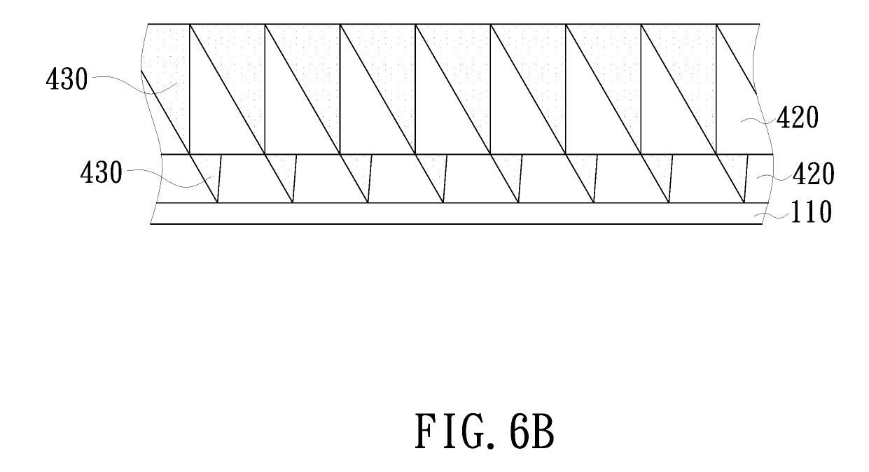

FIG. 6A and FIG. 6B illustrate a method of manufacturing the limiting viewing angle sheet 500. Referring to FIG. 6A and FIG. 6B, the method of manufacturing the limiting viewing angle sheet 500 is substantially the same as that of the manufacturing method shown in FIGS. 3A to 3C, and the difference between them is that in the manufacturing method in FIGS. 3A to 3C, the transparent layer 120 is formed on the substrate 110, and in the manufacturing method in FIG. 6A and FIG. 6B, the upper one of the transparent layers 420 is formed above the lower one of the transparent layers 420. That is, in the embodiment of FIG. 6A and FIG. 6B, the upper one of the transparent layer 420 is substantially formed on a limited viewing sheet with a single layer structure (e.g., the limiting viewing angle sheet 100, 200 or 300 of the previous embodiment), as shown in FIG. 6A.

After forming the transparent layer 420 having multiple grooves 422 on another transparent layer 420, the opaque pattern 430 is formed within these grooves 422 of the upper transparent layer 420 as described above with respect to the embodiment of FIGS. 3A to 3C. Referring to FIG. 6B and FIG. 5, a portion of both the transparent layer 420 and the opaque pattern 430 is then removed to reduce the thickness of the transparent layer 420 and the thickness of the opaque pattern 430, wherein the removal method may be polishing. Thus, the limiting viewing angle sheet 500 has been substantially finished, as shown in FIG. 5.

To sum up, by the aforementioned opaque pattern, the limiting viewing angle sheet of the aforementioned embodiment of the present invention may produce an asymmetric viewing angle. The limiting viewing angle sheets disclosed in the above embodiments are more suitable for use in other technical fields other than privacy filters, such as vehicle display technology, as compared to the conventional limiting viewing angle sheet applied to the privacy filter. In detail, the above-described limiting viewing angle sheets with asymmetric viewing angles may be installed on the screen of the panel or the on-board computer (OBC) in the vehicle to control the viewing angle, so that the image displayed on the screen will not project to the windshield which will interfere with the driver.

The foregoing is merely illustrative of the embodiments of the present invention and is not intended to be limiting of the present invention. While the invention has been disclosed by way of example with reference to the preferred embodiments, it is not intended to be limiting of the invention, any person skilled in the art may, within the scope of the technical solutions of the present invention, make equivalent embodiments in which the alteration or modification is made to equivalence is made by the method and the technical contents disclosed above. Any and all modifications, equivalents, and modifications of the foregoing embodiments are within the scope of the technical scope of the present invention without departing from the scope of the technical solution of the present invention in accordance with the technical details of the present invention.

What is claimed is:

1. A limiting viewing angle sheet, comprising:
a substrate;
a transparent layer, disposed on the substrate and comprising a top plane and a plurality of grooves formed on the top plane, wherein each of the grooves comprising a width reduced from the top plane to the substrate; and
an opaque pattern formed within the grooves and comprising a top surface and a plurality of side planes, wherein the top surface is exposed from the transparent layer, the side planes extend from the top surface, and the opaque pattern comprises two included angles respectively between the top surface and two of the side planes, and the two included angles are different to each other.

2. The limiting viewing angle sheet according to claim 1, wherein the opaque pattern is a mesh pattern, a bar pattern, or an array dot pattern.

3. The limiting viewing angle sheet according to claim 1, wherein one of the grooves comprises a plurality of side walls, and the side walls of the same one of the grooves intersect at a point or a line.

4. The limiting viewing angle sheet according to claim 1, wherein the substrate comprises a support plane, and the transparent layer is disposed on the support plane, the side planes of the opaque pattern comprise a plurality of first side planes and a plurality of second side planes, the opaque pattern comprises a width between two adjacent ones of the first side planes and the second side planes, which is gradually reduced from the top surface toward the support plane.

5. The limiting viewing angle sheet according to claim 4, wherein an included angle between each of the first side planes and the support plane is not equal to an included angle between each of the second side planes and the support plane.

6. A limiting viewing angle sheet, comprising:
a substrate;
a plurality of transparent layers stacked to each other and disposed on the substrate, wherein each of the transparent layers comprises a top plane and a plurality of grooves formed on the top plane, wherein each of the grooves comprises a width gradually decreased from the top plane to the substrate; and
a plurality of opaque patterns, respectively formed within the grooves of one of the transparent layers, and each of the opaque patterns comprises a top surface, a plurality of first side planes, and a plurality of second side planes, wherein the first side planes and the second side planes extend from the top surface, each of the opaque patterns comprises two different included angles respectively between the first side planes and the top surface, and the second side planes and the top surface.

7. The limiting viewing angle sheet according to claim 6, wherein the substrate comprises a support plane, and the transparent layers are disposed on the support plane, each of the opaque patterns comprises a width between two adjacent ones of the first side planes and the second side planes, which is gradually decreased from the top surface to the support plane.

8. The limiting viewing angle sheet according to claim 6, further comprising at least a glue layer disposed between two adjacent ones of the transparent layers.

9. A method for manufacturing a limiting viewing angle sheet, comprising:
forming a transparent layer on a substrate, wherein the transparent layer comprises a top plane and a plurality of grooves formed on the top plane, and each of the grooves comprises a width gradually decreased from the top plane to the substrate;
forming an opaque pattern within the grooves; and
removing a portion of the transparent layer and a portion of the opaque pattern for decreasing a thickness of the transparent layer and a thickness of the opaque pattern.

10. The method for manufacturing the limiting viewing angle sheet according to claim 9, wherein forming the transparent layer comprises steps of:
forming a transparent film on the substrate; and
having a mold pressed against the transparent film for forming the grooves.

11. The method for manufacturing the limiting viewing angle sheet according to claim 10, further comprising a step of heating the transparent film while having the mold compressing the transparent film.

12. The method for manufacturing the limiting viewing angle sheet according to claim 9, wherein forming the opaque pattern within the grooves comprises:
filling an opaque filling material within the grooves; and
solidifying the opaque filling material.

13. The method for manufacturing the limiting viewing angle sheet according to claim 12, wherein the opaque filling material is an ink.

14. The method for manufacturing the limiting viewing angle sheet according to claim 9, wherein removing a portion of the transparent layer and a portion of the opaque pattern comprises polishing the transparent layer and the opaque pattern.

15. The method for manufacturing the limiting viewing angle sheet according to claim 9, wherein the substrate is the limiting viewing angle sheet according to claim 1.
